(19) United States
(12) Patent Application Publication
(10) Pub. No.: US 2014/0310876 A1
(43) Pub. Date: Oct. 23, 2014

(54) PATIENT SUPPORT OVERLOAD OR OBSTRUCTION DETECTION

(71) Applicant: CHG Hospital Beds Inc., London (CA)

(72) Inventors: Richard B. Roussy, London (CA); Christopher George, St. Thomas (CA)

(21) Appl. No.: 14/365,567

(22) PCT Filed: Dec. 14, 2012
(86) PCT No.: PCT/CA2012/001153

§ 371 Date: Jun. 13, 2014

Related U.S. Application Data
(60) Provisional application No. 61/576,971, filed on Dec. 16, 2011.

(51) Int. Cl. A61G 7/018; A61G 7/015

(52) U.S. Cl. CPC A61G 7/018; A61G 7/015
USPC 5/613

(57) ABSTRACT

A patient support device, such as a bed, includes a frame, a backrest or other platform movable with respect to the frame, and an actuator connecting the backrest to the frame. The actuator is configured to raise and lower, or otherwise move, the backrest or platform with respect to the frame. An actuator sensor is provided to sense movement of the actuator. A backrest sensor is provided to sense movement of the backrest. A controller is coupled to the actuator, the actuator sensor, and the backrest sensor. The controller is configured to stop the actuator from raising the backrest in response to a characteristic signal from the actuator sensor. The controller is further configured to stop the actuator from lowering the backrest in response to at least a characteristic signal from the backrest sensor. The characteristic signals are defined to prevent the backrest or platform from moving when obstructed or overloaded in order to reduce the chance of damage or injury.

### PRIORITY CLAIM

This application claims priority from International Application No. PCT/CA2012/001153, filed Dec. 14, 2012, which claims priority to U.S. Provisional Patent Application No. 61/576,971, filed Dec. 16, 2011, the contents of which are each herein incorporated by reference.

### FIELD OF THE INVENTION

This disclosure relates to patient support devices, such as beds, and more particularly, to detecting overload or obstruction in patient support platforms. In particular, the disclosure relates to the detection of overload or obstruction of headrests of beds and the controlling of movement of the headrest in response thereto.

### BACKGROUND

Patient support devices, such as beds used in hospitals and nursing homes, are often configurable into different positions. Many of such beds can be raised and lowered, as well as have backrests that can be tilted between a prone (sleeping) position and a raised (sitting) position. These positions are typically controlled by one or more actuators, which are often electrically powered.

Backrests or other such moveable platforms can be overloaded or obstructed, and thus may be prevented from moving as expected. This can cause damage to the actuator or other mechanism component. What's more, if the obstruction is caused by a person's arm or other body part, injury may result.

### SUMMARY OF THE INVENTION

A platform, such as a backrest, of a patient support device, such as a bed, is controlled in a way that detects and responds to obstruction or overload. To carry out this detection, an actuator sensor is referenced when the platform is being moved in a first direction (e.g., raised) and a platform sensor is referenced when the platform is being moved in a second direction (e.g., lowered). The actuator sensor can additionally be referenced in the second direction. A response to detecting the obstruction or overload can include one or more of backing off the actuator by a limited amount and issuing an alarm.

### BRIEF DESCRIPTION OF THE DRAWINGS

The drawings illustrate, by way of example only, embodiments of the present disclosure.

FIG. 1 is a perspective view of a bed, as an example of a patient support device having a moveable platform.

FIG. 2 is a side view of an actuator assembly of the bed.

FIG. 3 is a functional block diagram of a controller for the actuator assembly.

FIG. 4 is a flowchart of a first example program for the controller.

FIG. 5 is a flowchart of a second example program for the controller.

FIG. 6 is a flowchart of a third example program for the controller.

### DETAILED DESCRIPTION

A bed is used by way of example to illustrate many of the embodiments described herein. However, other patient support devices, such as adjustable chairs, are also suitable for use with the invention. Moreover, the term “patient” is not intended to be limiting, and can be taken to apply to anyone, such as individuals undergoing long-term care, hospital patients, and nursing home residents, to name a few.

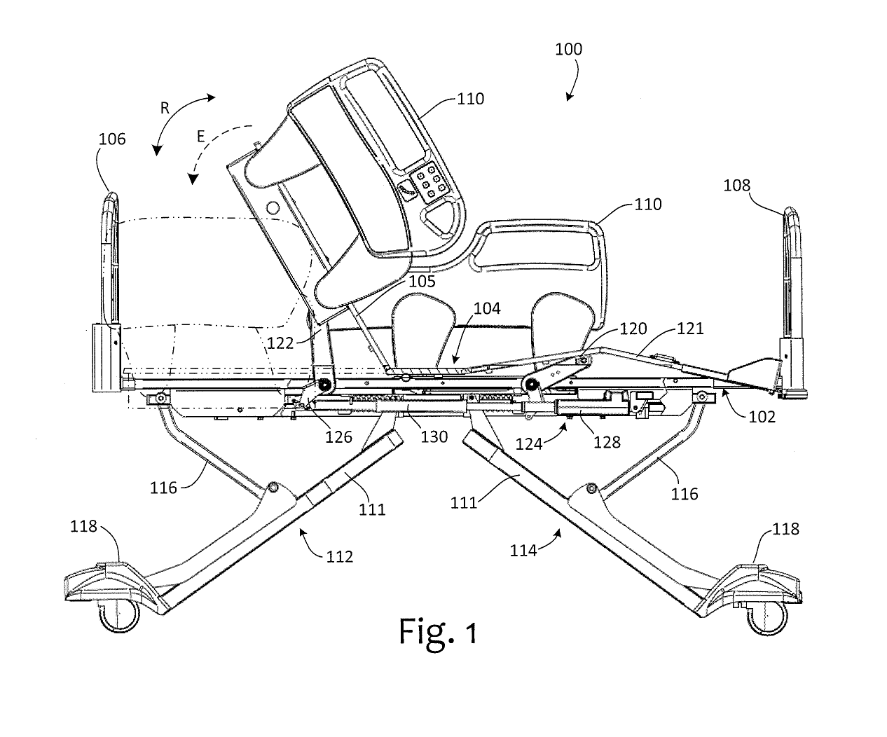

FIG. 1 illustrates an example of a bed 100. The bed 100 includes a substantially horizontal bed frame 102 with an adjustable mattress support 104 positioned thereon to receive a mattress (not shown) for supporting a person. In this embodiment, the mattress support 104 has a backrest 105 or other platform capable of moving, and in this case, tilting up and down (raised position shown). At the head of the bed 100 is a headboard 106, while a footboard 108 is connected to the bed frame 102 at the foot end of the bed 100. One or more side rails 110 are positioned on each side of the bed 100. In this example, two side rails 110 are provided on each side of the bed 100, making four side rails in total. The two side rails 110 positioned at the head end of the bed 100 tilt with the backrest 105. Any of the side rails 110 may be moveable so as to facilitate entry and exit of a person.

The bed 100 includes two leg assemblies 112, 114, each having two legs 111. The head leg assembly 112 is connected at the head of the bed 100 and the foot leg assembly 114 is connected at the foot of the bed 100. Upper portions of the legs 111 of the leg assemblies 112, 114 are connected to one or more linear actuators (not shown) that can move the upper portions of the legs 111 back and forth along the length of the bed 100. Leg braces 116 pivotably connected to the legs 111 and to the bed frame 102 constrain the actuator movement applied to the legs 111 to move the leg assemblies 112, 114 in a manner that raises and lowers the bed frame 102. In other words, the leg assemblies 112, 114 are linkages that collapse and expand to respectively lower and raise the bed frame 102. The lower ends of the leg assemblies 112, 114 are connected to caster assemblies 118 that allow the bed 100 to be wheeled to different locations.

The bed 100 further includes an attendant's control panel (not shown) at the footboard 108 that can, among other things, control the height of the bed frame 102 above the floor, as well as the tilt of the backrest 105 of the mattress support 104. The bed 100 further includes a controllable knee-height adjustment mechanism 120 to move one or more lower-body support platforms 121. To allow for similar adjustment, an occupant's control panel (not shown) can be provided, for example, on a side rail 110.

It should be emphasized that the bed 100 is merely one example of a bed or other patient support that may be used with the obstruction or overload detection and/or actuator control techniques described herein. Other examples of beds that can be used include ultra-low type height-adjustable beds such as those disclosed in US Patent Publication No. 2011/113556 and U.S. Pat. No. 7,003,828, the entirety of both documents being incorporated herein by reference.

As mentioned, the backrest 105 of the mattress support 104 is variably positionable, and accordingly can be raised and lowered so that the occupant of the bed 100 can be provided with, for example, a range of positions between fully prone and sitting upright. A backrest support 122 is pivotably connected to the bed frame 102 and supports the backrest 105 over its range of positions.

A backrest actuator assembly 124 is connected between the backrest 105 and the bed frame 102 and is configured to raise and lower the backrest 105 with respect to the bed frame 102. In this example, the backrest actuator assembly 124 includes a backrest actuator 128 that is connected to the bed frame 102. The backrest actuator assembly 124 further includes a damper 130 that is connected in series with the actuator 128 at one end, and that is pivotably connected to a lever arm 126 extending from the backrest support 122 at another end. The lever arm 126 may also be known as a head gatch bracket.

The actuator 128 can be an electric motor-driven linear actuator or other type of actuator, such as a hydraulic cylinder.

The damper 130 can be a fluid-filled damper, such as a hydraulic damper, gas spring, or the like. The damper 130 is configured to provide damping over a range of motion. For the linear style damper described herein, range of motion may be known as damper stroke. Generally, dampers may also be known as dampeners or dashpots.

The damper 130 can be a lockable damper that is configured to rigidly or nearly rigidly lock at any position on the range of motion. In one embodiment, the lockable damper 130 includes a cylindrical body through which a piston slides. Each side of the piston has a chamber of fluid that is selectively communicated by actuating an unlocking pin that opens a valve in the piston to allow fluid to move between the chambers. Relative movement between the cylindrical body and a rod extending from the piston can then be damped (valve open) or held rigid (valve closed). In another embodiment, the damper 130 is locked by a separate external locking mechanism. In yet another embodiment, other kinds of dampers can be used. The damper 130 can be, for example, a BLOC-O-LIFT™ device sold by Stabilus GmbH of Koblenz, Germany.

During normal operation of the bed 100, the damper 130 is locked in an extended state and movement of the actuator 128 causes the damper 130 to push or pull against the lever arm 126 to raise or lower (arrow R) the backrest 105 as commanded by the controller operated by the bed's occupant or an attendant, such as a nurse or caregiver.

The backrest actuator assembly 124 can further include a mechanical release, which can include a manually actuated handle, connected to the damper 130. Components of the release may also be provided in the damper 130. The release may be known as a cardiopulmonary resuscitation (CPR) quick release. The release is configured to unlock the lockable damper 130 when actuated to an unlocked position, thereby allowing the damper 130 to contract without the actuator 128 having to be operated. During an emergency, such as a cardiac arrest of the bed's occupant, the release can be manually actuated to quickly allow the backrest 105 to lower due to gravity as shown by arrow E (lowered position shown in phantom line). The rate of lowering of the backrest 105 is controlled at least in part by the damping effect of the damper 130 as it contracts over its damped range of motion under the weight of the backrest 105, backrest support 122, attached side rails 110, mattress, the occupant's upper body, and any other items in or on the backrest 105.

After the CPR release has been actuated and while the backrest 105 is lowering due to gravity, the release can be manually returned to its original position, or lock position, to lock the lockable damper 130 at its current length and thereby stop the lowering of the backrest 105. The backrest 105 can be stopped at any position along the damped range of motion, which can make for safer bed operation. For example, if the arm of the occupant or that of a person standing near the bed becomes caught under the backrest 105 during a CPR release, the backrest 105 can be temporarily stopped to reduce the chance of injury.

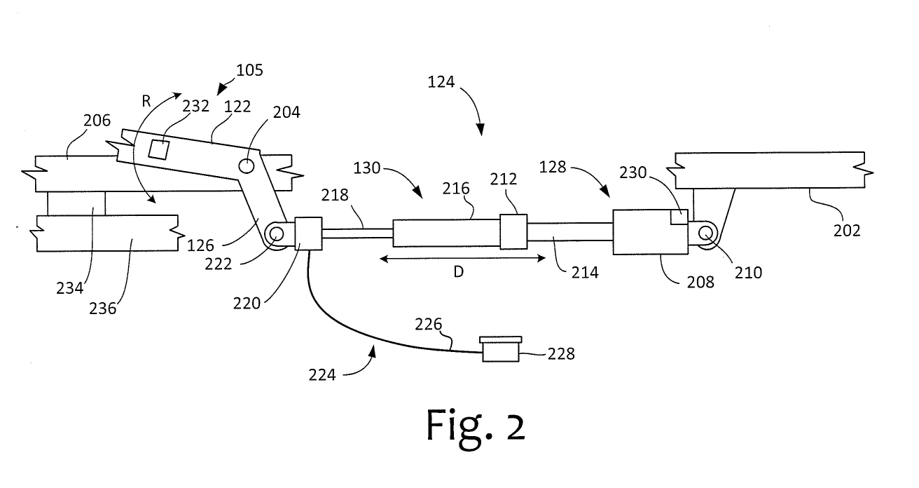

FIG. 2 shows a side-view diagram of the actuator assembly 124. The actuator assembly 124 connects a portion 202 of the bed frame 102 to the lever arm 126 that extends downward from the backrest support 122 opposite a pivot connection 204 to another portion 206 of the bed frame. As the actuator assembly 124 extends and retracts parallel to arrow D, the backrest support 122 rotates as indicated by arrow R.

The actuator assembly 124 includes the actuator 128 and the damper 130 connected in series with the actuator 128. Accordingly, the damper 130 is loaded in compression by the actuator 128 when the backrest support 122 is being raised to raise the backrest 105. The damper 130 is pulled by the actuator 128 when the backrest support 122 is being lowered to lower the backrest 105; however, the weight of the backrest support 122 and load that it carries generally keeps the damper 130 in compression.

The actuator 128 includes a housing 208 that is pin connected at 210 to the portion 202 of the bed frame. A connector block 212 connects an extendable and retractable rod 214 of the actuator 128 to the damper 130.

The damper 130 includes a cylinder 216 and an extendable and retractable rod 218 connected between the connector block 212 and a bearing block 220, which is pin connected at 222 to the lever arm 126 of the patient support device.

In this example, the damper 130 is a lockable damper, as described above. The damper 130 is normally locked rigid in an extended state. A release 224 includes a pull-cable 226 connected at one end to a manually operated handle 228 that is located on the bed. The other end of the pull cable 226 is connected to a damper release mechanism at the bearing block 220. Such a release mechanism can include a lever that interacts with an unlocking pin of the damper 130. Actuation of the handle 228 thus frees the damper 130 to extend or retract, and thus allows damped relative movement of the bearing block 220 with respect to the connector block 212.

The damper 130 is locked during normal raising and lowering of the lever arm 126. Moreover, the damper 130 provides damping over its range of motion when unlocked during, for example, an emergency lowering of the backrest support 122. After the damper 130 is compressed after an emergency lowering of the backrest support, the damper release mechanism can again be actuated to unlock the damper 130, and at the same time, the actuator 128 can be retracted to extend the damper to its normal operational length before the damper 130 is locked again.

Obstruction or overload detection techniques will now be described in the context of the above-described actuator assembly 124 having the actuator 128 in series with the damper 130. These obstruction or overload detection techniques may comprise actuator control techniques. It should be understood that these techniques can be used with other actuator assemblies, other beds, and other patient support platforms.

As shown in FIG. 2, an actuator sensor 230, a backrest sensor 232, and optionally at least one load sensor 234 are provided.

The actuator sensor 230 is configured to sense movement of the actuator 128. In this embodiment, the actuator sensor 230 is a rotary encoder located inside the housing 208 of the actuator 128. The actuator sensor 230 senses movement of a drive component, such as a rotating gear, of the actuator 128 and outputs a signal having pulses, where each pulse indicates a linear relative displacement of the actuator rod 214 with respect to the housing 208. In other embodiments, the actuator sensor 230 can be located elsewhere and can include other types of sensors such as one or more suitably positioned Reed switches or Hall effect sensors, an accelerometer, or the like.

The backrest sensor 232 is configured to sense movement of the backrest 105. In this embodiment, the backrest sensor 232 is an accelerometer attached to the backrest support 122. Accordingly, the backrest sensor 232 can output a signal indicative of an acceleration of the backrest 105, and such signal can be integrated to obtain a rate or speed of movement of the backrest 105 and integrated again to obtain a displacement of the backrest 105. In other embodiments, the backrest sensor 232 can be located elsewhere and can include other types of sensors such as an inclinometer, one or more suitably positioned Reed switches or Hall effect sensors, a rotary encoder, or the like.

The load sensor 234 is positioned to sense a load at the backrest 105. In this embodiment, two load sensors 234 are positioned at the head of the bed between the upper portion 206 of the bed frame and a lower frame portion 236 that connects to the leg assemblies 112, 114. The two load sensors 234 are located at opposite sides of the bed and may be designated head-left and head-right load sensors. The load sensors 234 can provide for measurement of the weight in the bed in conjunction with two similar load sensors positioned at foot-left and foot-right positions. Although the load sensed by the load sensors 234 may not be directly proportional to the weight on the backrest 105, the load sensors 234 output signals indicative of the weight on the backrest 105, such that the weight on the backrest 105 can be readily obtained by performing a calculation. In this example, the load sensors 234 are bending beam load cells. In other examples, the load sensor 234 can include other types of sensors. Other positions are also contemplated for the load sensor 234, such as between the backrest support 122 and the mattress. The load sensors 234 may be used in conjunction with one or both of the actuator sensor 230 or the backrest sensor 232 to provide redundant or alternative modes of detecting obstruction or overload.

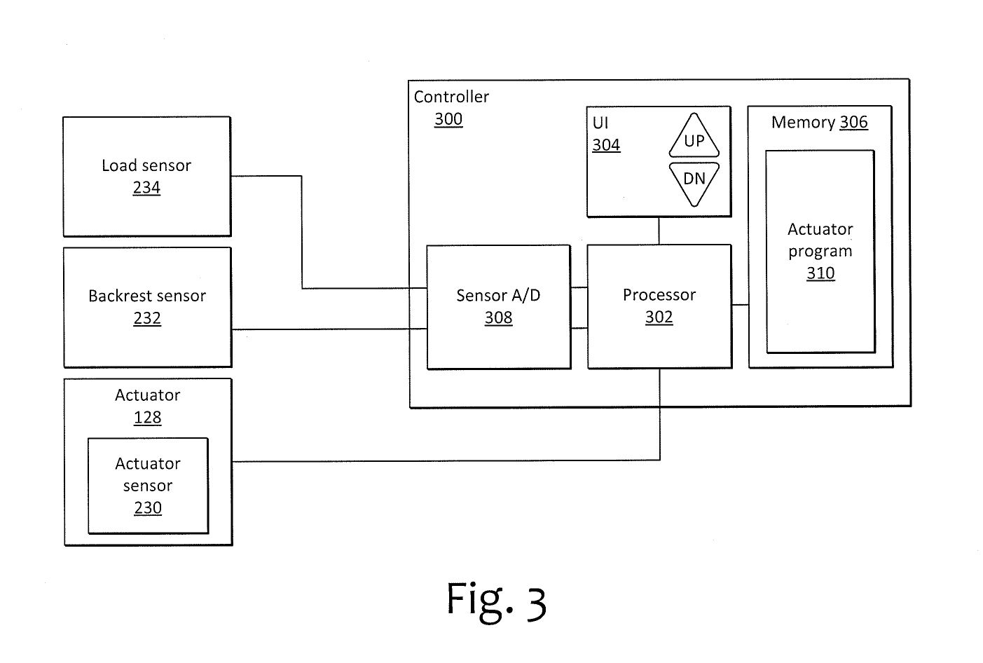

FIG. 3 shows a controller 300. The controller 300 includes a processor 302 connected to a user interface 304, a memory 306, and an analog-to-digital converter 308 for the backrest sensor 232 and load sensor 234. The analog-to-digital converter 308 can be omitted if the outputs of the backrest sensor 232 and load sensor 234 are digital. Signals between the processor 302 and the actuator 128 and actuator sensor 230 can be routed through the analog-to-digital converter 308 if these signals are analog.

The processor 302 can be a microcontroller of the kind that is readily commercially available for controlling actuators and auxiliary devices.

The user interface 304 can include buttons and a screen for controlling operation of the bed 100. For example, buttons can be provided to command the actuator 128 to raise and lower the backrest 105. Such buttons can include momentary contact switches, which may also be known as “hold-and-run” switches.

The memory 306 can be a random-access memory (RAM), a read-only memory (ROM), or the like. The memory 306 can store an actuator program 310 that includes instructions executable by the processor 302 for controlling the actuator 128 during normal operation. Specifically, the actuator program 310 includes instructions that generate control signals for the actuator 128 in response to commands received from the user interface 304. That is, the program 310 causes the processor 302 to output a backrest raising signal to the actuator 128 in response to receiving a backrest raising command at the user interface 304, and output a backrest lowering signal to the actuator 128 in response to receiving a backrest lowering command at the user interface 304. The actuator program 310 may further include maximum and minimum allowable extents of movement of the actuator 128, so that a commanded raising movement of the backrest 105 can be prevented when the backrest 105 is fully raised and a commanded lowering movement of the backrest 105 can be prevented when the backrest 105 is fully lowered. The actuator program 310 further includes instructions to stop actuation of the backrest 105 under certain conditions.

Specifically, in a first example, the program 310 configures the controller 300 to stop the backrest actuator 128 from raising the backrest 105 in response to a characteristic signal from the actuator sensor 230, and further, to stop the backrest actuator 128 from lowering the backrest 105 in response to characteristic signals from both the actuator sensor 230 and the backrest sensor 232. Stopping the backrest 105 in this way can prevent damage to the actuator 128 or injury to a person should the backrest 105 become obstructed or overloaded.

The program 310 includes instructions that interpret the characteristic signal from the actuator sensor 230 as being indicative of a rate of movement of the actuator 128 being lower (i.e., slower) than an expected rate of movement of the actuator 128. Since, in this example, the actuator sensor 230 is a rotary encoder, the characteristic signal from the actuator sensor 230 has a pulse rate lower than an expected pulse rate. Suppose, for example, that when the actuator 128 is extended or retracted the actuator sensor 230 is normally expected to output 500 pulses (+/−5 pulses) per second, which corresponds to a 1 inch (25 mm) per second extension or retraction of the actuator 128. The program 310 accordingly stores one or more expected pulse rates that are less than 495 pulses (500−5) per second. The characteristic signal from the actuator sensor 230 is then an actual pulse rate of less than 495 pulses per second, which indicates that something may be preventing the backrest 105 from moving normally in response to actuation by the actuator 128.

The program 310 further includes instructions that interpret the characteristic signal from the backrest sensor 230 as being indicative of a rate of lowering of the backrest 105 being lower (i.e., slower) than an expected rate of lowering. In this example, the backrest sensor 230 is an accelerometer that provides acceleration signals to the processor 302. The program 310 integrates the accelerations to obtain velocities that are then further processed by the program 310, taking into account the location of the backrest sensor 230, to obtain at least an angular speed of the backrest 105. Continuing the above numerical example, suppose that the 1 inch (25 mm) per second normal rate of extension or retraction of the actuator 128 corresponds to a 1 degree per second normal angular speed of raising or lowering the backrest 105. The program 310 accordingly stores an expected angular rate of lowering of the backrest of 0.95 degrees per second (5% being allocated for sensor error or other consideration). The characteristic signal from the backrest sensor 230 is then a signal that corresponds to 0.95 degrees per second or slower, which indicates that something may be preventing the backrest 105 from moving normally in response to actuation by the actuator 128.

The characteristic signals from the actuator sensor 230 and the backrest sensor 230 are referenced as follows to stop the backrest in case of obstruction or overload.

When the backrest 105 is being raised, the program 310 references a stored expected actuator pulse rate for raising. The program 310 monitors the measured or actual pulse rate from the actuator sensor 230, compares the actual pulse rate with the expected pulse rate for raising, and then stops the actuator 128 when the actual pulse rate is lower than the expected pulse rate for raising. Continuing the numerical example, the stored expected pulse rate for raising can be 490 pulses per second, which allows for a small reduction in backrest raising rate that may be due to, for example, a heavier than usual occupant shifting his/her weight.

When the backrest is being lowered, the program 310 references the stored expected angular rate of lowering of the backrest 105, discussed above, and further references a stored expected actuator pulse rate for lowering of the backrest 105. The program 310 monitors the measured or actual angular rate of lowering of the backrest 105 computed based on the backrest sensor 232 and monitors the measured or actual pulse rate from the actuator sensor 230. The program 310 compares the actual angular rate with the expected angular rate of lowering and compares the actual pulse rate with the expected pulse rate for lowering. The program 310 stops the actuator 128 when the actual angular rate is lower than the expected angular rate of lowering and/or the actual pulse rate is lower than the expected pulse rate for lowering. Continuing the numerical example, the stored expected angular rate of lowering is 0.95 degrees per second and the stored expected pulse rate for lowering can be 495 pulses per second. In this example, the stored expected pulse rate for lowering is higher than the stored expected pulse rate for raising. Thus, when the actuator sensor 230 outputs a pulse rate of lower than 495 pulses per second and/or the backrest sensor 232 outputs a signal that corresponds to an actual angular rate of less than 0.95 degrees per second, then the actuator 128 is stopped.

In this example, only the actuator sensor 230 is referenced during backrest raising as it is expected that the actuator sensor 230 will respond rapidly to obstructions and before damage to the actuator 128 can occur. On the other hand, the backrest sensor 232 is used in conjunction with the actuator sensor 230 during lowering of the backrest 105 because the actuator 128 may continue to move after the lowering backrest is obstructed due to mechanical play (i.e., looseness) in the actuator assembly 124, such as a tendency for the damper 130 to more readily extend than contract or play in the damper release mechanism. Pin connections may also have play that may contribute to an overall mechanical hysteresis that may be exhibited when the backrest 105 is obstructed from lowering while the actuator 128 is retracting. Therefore, the pulse rate of the actuator sensor 230 may not decrease rapidly enough to stop the actuator 128 in time to prevent damage or injury. Accordingly, the backrest sensor 232 is also referenced during lowering as a way of correlating a slight decrease in the pulse rate of the actuator sensor 230 with an immobile backrest 105. However, both the actuator sensor 230 and the backrest sensor 232 can be used during raising in the same manner as described for lowering to provide additional flexibility or redundancy when detecting the presence of an obstruction or overload condition. The characteristic signals of both the backrest sensor 232 and the actuator sensor 230 can be used together to increase the accuracy and speed of determination of an obstruction being present. The characteristic signals of the actuator sensor 230 and the backrest sensor 232 that indicate the need to stop the backrest actuator 128 need not be constant. For example, each of the expected pulse rate for lowering the backrest 105, the expected pulse rate for raising the backrest 105, and the expected angular rate of lowering the backrest 105 can vary with respect to backrest position or load, as measured by load sensor 234. One or more formulas or lookup tables can be referenced by the program 310 to establish each of these expected values based on backrest position or load. For example, the backrest 105 may move faster when higher and may move slower when lower, and the characteristic signals can be defined to accommodate for this.

After the backrest 105 has been stopped, additional safeguards may be taken.

The program 310 can further configure the controller 300 to command a limited reverse movement from the actuator 128 in response to at least one of the characteristic signals. That is, after the actuator 128 is stopped in response to an obstruction, the actuator 128 can be backed-off by a small amount to release stress/strain from the actuator assembly 124 and reduce any pinching of the backrest 105 or related structure on the obstruction. In this example, the limited reverse movement of the actuator 128 is accomplished by reversing the actuator direction for about half a second. The program 310 can further configure the controller 300 to generate an alarm signal in response to at least one of the characteristic signals. The alarm signal can be issued to an alarm device, such as a speaker, light, or similar device, to output an audible or visual alert to warn the operator of the bed of the detection of an obstruction or overload condition.

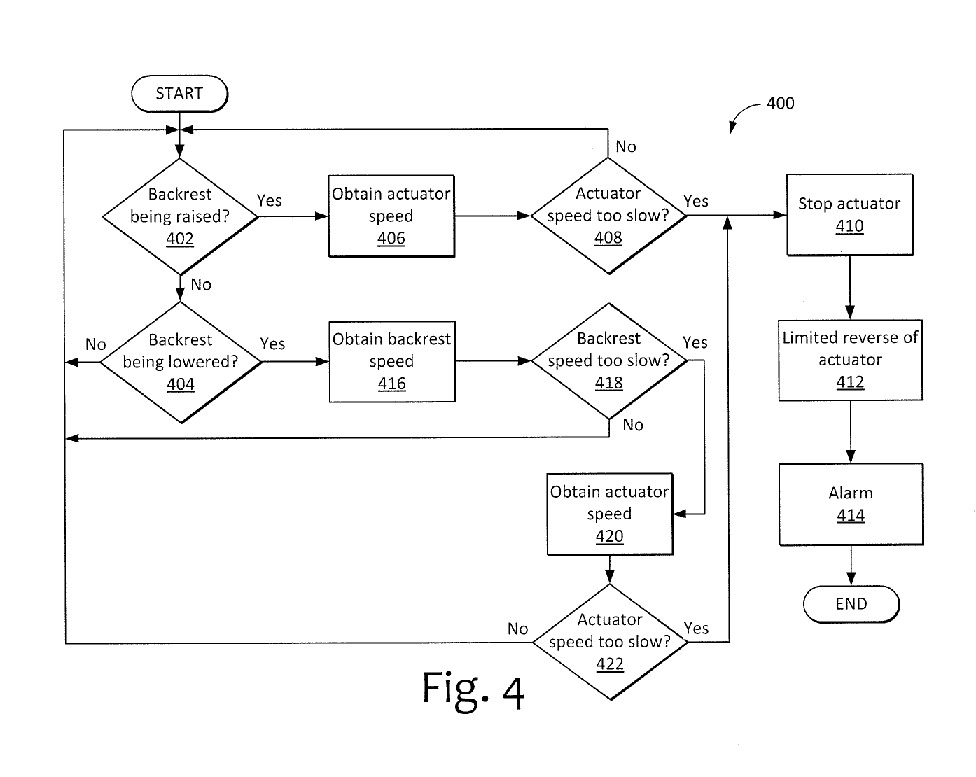

Referring to the flowchart of FIG. 4, a method 400 can be used as a basis for the program 310 in the first example described above.

At 402 and 404 it is determined whether a command is being issued to extend or retract the actuator 128, for example to result in raising or lowering of the backrest 105. If the controller 300 is not commanding movement of the backrest 105, for example no one is pressing and holding the up or down button on the user interface 304, then the remainder of the method 400 need not be performed until such a command occurs. The check performed at 402 and 404 can be periodically made at a rate of, for example, several times a second.

Once it has been determined that a command to raise the backrest 105 has been received, at 406, the speed of the actuator 128 is sensed. This can be performed by the actuator sensor 230, such as the rotary encoder, as discussed above. During this time, the actuator 128 extends. Step 406 can be combined with step 402, as sensing actuator speed is one way of determining that the backrest is being raised.

At 408, the measured or actual speed of the actuator 128 is compared with an expected speed of the actuator 128. The expected speed of the actuator 128 can be a constant or can be variable with respect to the position of the backrest 105 or load on the backrest 105, as discussed above. If the actual speed is not too slow, no action need be taken and the method 400 returns to the start. If the actual speed is detected to be too slow, it is determined that the backrest 105 is in an obstructed or overloaded condition, and accordingly the actuator 128 is stopped, at 410.

Also in response to the obstructed or overloaded condition, at 412, the actuator 128 can then be automatically reversed by a limited amount or for a limited time to relieve stress/strain or free the obstruction. At about the same time, an alarm can be issued to alert the operator to the problem, at 414.

On the other hand, if it has been determined that a command to retract the actuator and/or lower the backrest 105 has been issued, at 416, the speed of the backrest 105 is determined. This can be performed by the backrest sensor 232, such as the accelerometer, as discussed above, and may involve computing a velocity from a sensed acceleration. During this time, the actuator 128 retracts and accordingly lowers the backrest 105. Step 416 can be combined with step 404, as sensing the backrest speed is one way of determining that the backrest is being lowered.

At 418, the speed of the backrest 105 is compared with an expected speed of the backrest 105. The expected speed of the backrest 105 can be a constant or can be variable with respect to the position of the backrest 105 or load on the backrest 105, as discussed above. If the backrest speed is not too slow, no action need be taken and the method 400 returns to the start. If the expected speed is detected to be too slow, it is determined that the backrest 105 may be in an obstructed or overloaded condition, and accordingly the actuator 128 speed is obtained and compared to an expected speed of the actuator 128, at 420 and 422. For steps 420 and 422, the description above for steps 406 and 408 can be referenced, however, the expected speed for lowering, used at 422, can be different from the expected speed for raising, used at 408.

If it is determined at 422 that the actual speed of the actuator is too slow, then it is determined that the backrest 105 is in an obstructed or overloaded condition, and accordingly the actuator 128 is stopped, at 410. The actuator 128 can then be automatically reversed by a limited amount or for a limited time to relieve stress/strain or free the obstruction, at 412, and the alarm can be issued to alert the operator to the problem, at 414.

The steps of the method 400 can be performed in orders different from those described above. For example, the positions of steps 416 and 418 can be swapped with the positions of steps 420 and 422, such that the actuator speed is evaluated before the backrest speed. Moreover, the raising/lowering determination at 402 and 404 can be made after or while the actuator speed is obtained.

In other examples, the stored expected pulse rate for lowering can be selected to be equal to or greater than that for raising. In still other examples, the program 310 uses the backrest sensor 232 as the condition for detecting an obstruction at the backrest 105 during lowering unless the output of the backrest sensor 232 is erroneous, too noisy, or otherwise corrupt, in which case the program 310 uses the actuator sensor 230 as the condition for detecting an obstruction at the backrest 105. In still other examples, the program 310 references only the backrest sensor 232 as the condition for detecting an obstruction at the backrest 105 during lowering. Some of these examples will now be discussed below.

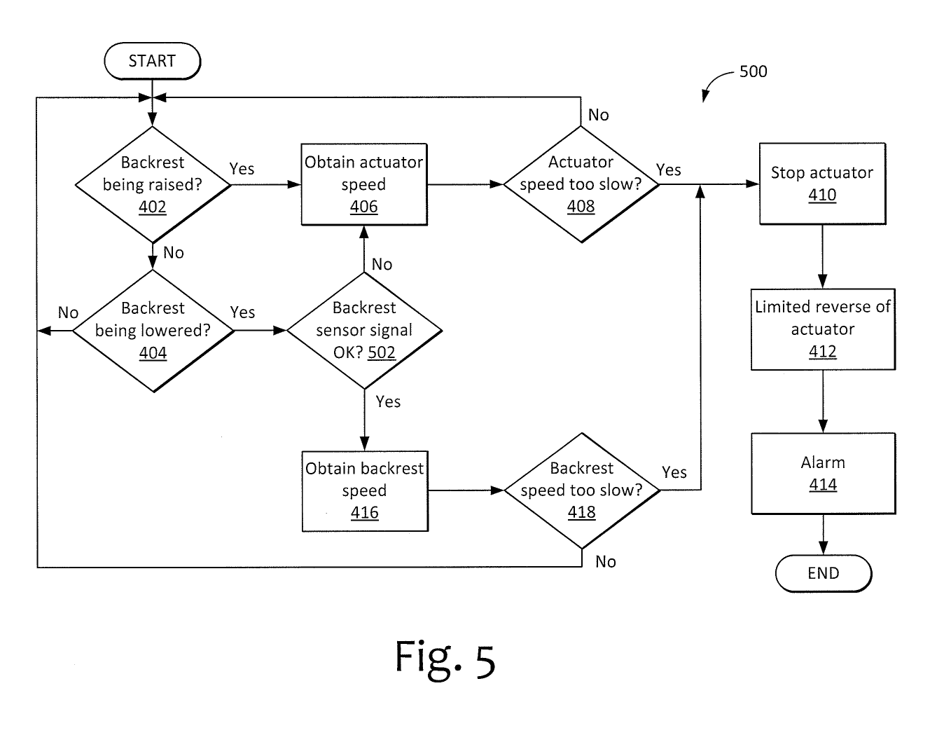

Referring to the flowchart of FIG. 5, a method 500 can be used as a basis for a second example of the program 310. Most steps of the method 500 are the same as the method 400, and the above description can be referenced for steps with like reference numerals.

When the backrest is being lowered at 404, a signal from the backrest sensor 232 is assessed to determine whether the signal is acceptable, at 502. Reasons that the signal may be unacceptable include, but are not limited to, the following: the backrest sensor 232 has failed, the signal is too noisy, the signal is outside a predetermined acceptable range (i.e., the signal is erroneous), or the signal is delayed. If the signal is unacceptable, then only the actuator speed is used to control stopping of the backrest 105 in case of obstruction or overload, and the method progresses to 406. Step 406 can reference the same expected actuator speed as when raising the backrest 105 or a different expected actuator speed, as triggered by the arrival at step 406 from step 502. If the backrest sensor 232 signal is acceptable, then step 416 is performed and only the backrest speed is used to control stopping of the backrest 105 in case of obstruction or overload.

The method 500 for the second example of the program 310 thus relies on the backrest sensor 232 during lowering if its output is acceptable, and otherwise reverts to using the actuator sensor 230.

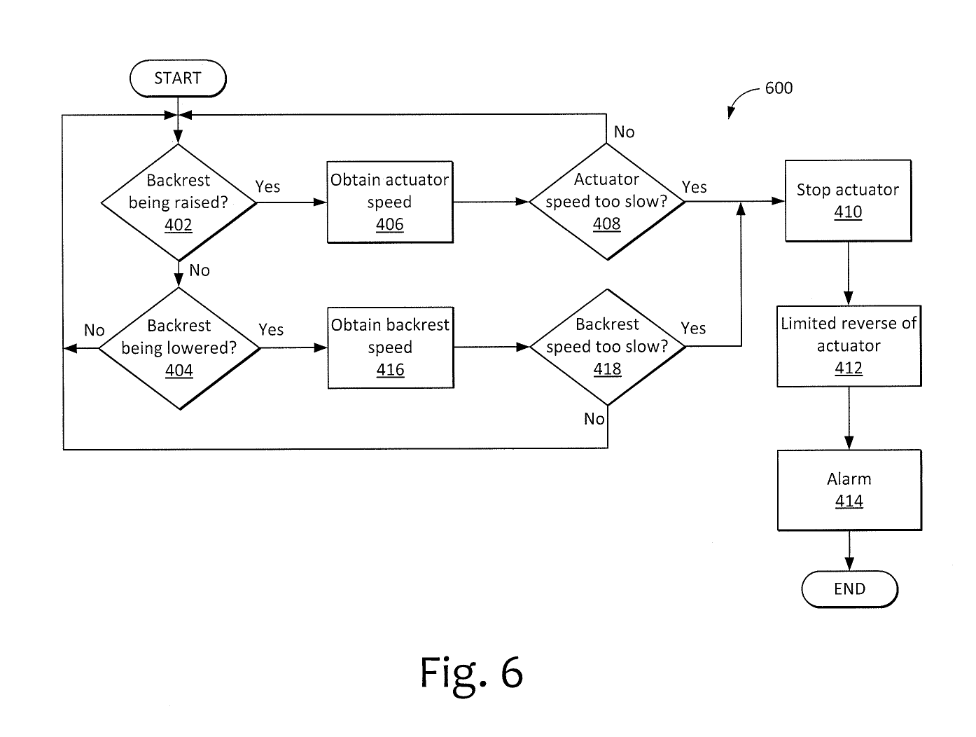

Referring to the flowchart of FIG. 6, a method 600 can be used as a basis for a third example of the program 310. Most steps of the method 600 are the same as the method 400, and the above description can be referenced for items with like reference numerals.

The method 600 relies on only the backrest sensor 232 to stop the lowering of the backrest 105 in case of obstruction or overload. That is, at 418, if referencing the backrest sensor 232 determines that the backrest 105 speed is too slow, the actuator is immediately stopped at 410 without referencing the actuator sensor 230. In this example, the backrest sensor 232 is sensitive or reliable enough to be relied on for detecting obstruction or overload during lowering of the backrest 105.

In the above, speed or rate of actuator or platform (backrest) movement is used to determined when to stop movement of the platform (backrest) in case of obstruction or overload of the platform (backrest). In other examples, displacement can be used instead of speed.

Persons of skill in the art will readily understand that the techniques described herein for detecting obstruction or overload and/or controlling movement are applicable to other elements of the patient support other than the backrest. For example, actuators for height adjustment of the patient support platform, knee or foot height/angle adjustment, platform width, etc., may all use embodiments of the techniques described herein to similar effect. In addition, various combinations of the sensors described herein may be used to provide redundancy or increased speed/accuracy of obstruction detection, depending on the expected obstruction modes for the actuator to which they are applied. Various alarm modes may be implemented in conjunction with obstruction detection. “Obstruction” is meant to include interference between any portion of the patient support or platform and any person or thing that might impede or tend to impede motion of the patient support or platform. This includes interference between the platform (and/or accessories of the bed attached to the platform, such as the siderails) and people, walls, floors, furniture and/or, ancillary equipment in the room. “Overload condition” is meant to include conditions whereby allowable load limits are exceeded, irrespective of the presence of obstructions, on components of the patient support or platform. “Actuator sensor” is meant to include all types of linear position sensors, whether internal or external to the actuator. “Backrest sensor” is meant to include all types of movement based sensors, whether located on the backrest or another part of the patient support or platform. The movement based sensors may include sensors that measure angular movement or acceleration. “Load sensor” is meant to include sensors that measure strain or deflection. Other types of sensors not explicitly described herein that produce similar effects suitable for use with the present invention are known to those skilled in the art.

While the foregoing provides certain non-limiting example embodiments, it should be understood that combinations, subsets, and variations of the foregoing are contemplated. The monopoly sought is defined by the claims.

What is claimed is:

1. A bed comprising:
a bed frame;
a backrest pivotable with respect to the bed frame;
a backrest actuator connecting the backrest to the bed frame, the backrest actuator configured to raise and lower the backrest with respect to the bed frame;
an actuator sensor positioned to sense movement of the backrest actuator;
a backrest sensor positioned to sense movement of the backrest; and
a controller coupled to the backrest actuator, the actuator sensor, and the backrest sensor, the controller configured to stop the backrest actuator from raising the backrest in response to a characteristic signal from the actuator sensor, the controller further configured to stop the backrest actuator from lowering the backrest in response to characteristic signals from both the actuator sensor and the backrest sensor.

2. The bed of claim 1, wherein the controller is further configured to command a limited reverse movement from the backrest actuator in response to at least one of the characteristic signals.

3. The bed of claim 2, wherein the limited reverse movement of the actuator is less than about 0.5 inches.

4. The bed of any one of claims 1 to 3, wherein the controller is further configured to generate an alarm signal in response to at least one of the characteristic signals.

5. The bed of any one of claims 1 to 4, further comprising a backrest actuator assembly having the backrest actuator and a damper.

6. The bed of claim 5, wherein the damper is in series with the backrest actuator.

7. The bed of any one of claims 5 to 6, wherein the damper is positioned to tend to be compressed by the actuator when the backrest is being raised.

8. The bed of any one of claims 5 to 7, wherein the damper is positioned to tend to be extended by the actuator when the backrest is being lowered.

9. The bed of any one of claims 1 to 8, wherein the characteristic signal from the actuator sensor is indicative of a rate of movement of the actuator being lower than an expected rate of movement of the actuator.

10. The bed of any one of claims 1 to 9, wherein the characteristic signal from the backrest sensor is indicative of a rate of lowering of the backrest being lower than an expected rate of lowering.

11. The bed of any one of claims 1 to 10, wherein the actuator sensor comprises a rotary encoder.

12. The bed of claim 11, wherein the characteristic signal from the actuator sensor is indicative of a pulse rate from the rotary encoder being lower than an expected pulse rate.

13. The bed of claim 12, wherein the backrest sensor comprises an accelerometer.

14. The bed of claim 12, wherein the backrest sensor comprises an inclinometer.

15. The bed of any one of claims 13 to 14, wherein the characteristic signal from the backrest sensor is indicative of a rate of lowering of the backrest being lower than an expected rate of lowering.

16. A bed comprising:
a bed frame;
a backrest pivotable with respect to the bed frame;
a backrest actuator connecting the backrest to the bed frame, the backrest actuator configured to raise and lower the backrest with respect to the bed frame;
an actuator sensor positioned to sense movement of the backrest actuator;
a backrest sensor positioned to sense movement of the backrest; and
a controller coupled to the backrest actuator, the actuator sensor, and the backrest sensor, the controller configured to stop the backrest actuator from raising the backrest in response to a characteristic signal from the actuator sensor, the controller further configured to stop the backrest actuator from lowering the backrest in response to a characteristic signal from the backrest sensor.

17. A patient support comprising:
a frame;
a platform movable with respect to the frame, the platform configured to at least partially support a patient;
an actuator connecting the platform to the frame, the actuator configured to move the platform with respect to the frame;
an actuator sensor positioned to sense movement of the actuator;
a platform sensor positioned to sense movement of the platform; and
a controller coupled to the actuator, the actuator sensor, and the platform sensor, the controller configured to stop the actuator from moving the platform in a first direction in response to a characteristic signal from the actuator sensor, the controller further configured to stop the actuator from moving the platform in a second direction in response to characteristic signals from both the actuator sensor and the platform sensor.

18. A controller configured to be coupled to an actuator of a moveable platform of a patient support, an actuator sensor, and a platform sensor positioned to detect movement of the platform, the controller comprising:
a memory storing an actuator program;
a processor coupled to the memory and configured to execute the actuator program, the program causing the processor to stop the actuator from raising the platform in response to a characteristic signal from the actuator sensor, the controller further configured to stop the actuator from lowering the platform in response to characteristic signals from both the actuator sensor and the platform sensor.

19. A method of operating a bed, the method comprising:
receiving a command to move a backrest of the bed;
moving the backrest according to the command using an actuator;
determining a speed of movement of the backrest;
determining a speed of movement of the actuator; and
in response to a condition in which the speed of movement of the backrest is lower than an expected speed of the backrest and the speed of movement the actuator is lower than an expected speed of the actuator, stopping the actuator.

20. The method of claim 19, wherein moving the backrest according to the command using the actuator comprises lowering the backrest.

21. The method of any one of claims 19 to 20, further comprising, in response to the condition and after stopping the actuator, reversing the actuator a limited amount.

22. The method of any one of claims 19 to 21, further comprising, in response to the condition, issuing an alarm.

23. A method of operating a bed, the method comprising:
receiving a command to move a backrest of the bed;
moving the backrest according to the command using an actuator;
determining that a signal from a sensor positioned at the backrest to determine the speed of movement of the backrest is unacceptable;
determining a speed of movement of the actuator; and
in response to a condition in which the speed of movement the actuator is lower than an expected speed of the actuator, stopping the actuator.

24. The method of claim 23, wherein moving the backrest according to the command using the actuator comprises lowering the backrest.

25. The method of any one of claims 23 to 24, further comprising, in response to the condition and after stopping the actuator, reversing the actuator a limited amount.

26. The method of any one of claims 24 to 25, further comprising, in response to the condition, issuing an alarm.

27. A patient support device having a moveable platform coupled with an actuator, the device having an obstruction or overload detection system for the platform, the system comprising a linear position sensor, a movement sensor and/or a load sensor interfaced with a controller for the actuator.
